(19) United States
(12) Patent Application Publication
(10) Pub. No.: US 2014/0047543 A1
(43) Pub. Date: Feb. 13, 2014

(54) APPARATUS AND METHOD FOR DETECTING HTTP BOTNET BASED ON DENSITIES OF WEB TRANSACTIONS

(71) Applicant: Electronics and Telecommunications Research Institute, Daejeon (KR)

(72) Inventors: Sung-Jin KIM, Daejeon (KR); Jong-Moon LEE, Daejeon (KR); Byung-Chul BAE, Daejeon (KR); Hyung-Geun OH, Daejeon (KR); Ki-Wook SOHN, Daejeon (KR)

(73) Assignee: Electronics and Telecommunications Research Institute, Daejeon (KR)

(21) Appl. No.: 13/958,552

(22) Filed: Aug. 3, 2013

(30) Foreign Application Priority Data
Aug. 7, 2012 (KR) 10-2012-0086328

(51) Int. Cl. H04L 29/06

(52) U.S. Cl. CPC H04L 63/1441
USPC 726/23

(57) ABSTRACT

An apparatus and method for detecting a Hyper Text Transfer Protocol (HTTP) botnet based on the densities of transactions. The apparatus includes a collection management unit, a web transaction classification unit, and a filtering unit. The collection management unit extracts metadata from HTTP request packets collected by a traffic collection sensor. The web transaction classification unit extracts web transactions by analyzing the metadata, and generates a gray list by arranging the extracted web transactions according to the frequency of access. The filtering unit detects an HTTP botnet by filtering the gray list based on a white list and a black list.

### CROSS REFERENCE TO RELATED APPLICATION

This application claims the benefit of Korean Patent Application No. 10-2012-0086328, filed on Aug. 7, 2012, which is hereby incorporated by reference in its entirety into this application.

### BACKGROUND OF THE INVENTION

1. Technical Field

The present invention relates generally to an apparatus and method for detecting a Hyper Text Transfer Protocol (HTTP) botnet based on the densities of web transactions and, more particularly, to an apparatus and method that detect an HTTP botnet by analyzing a white list and a black list based on the densities of web transactions.

2. Description of the Related Art

A botnet is a collection of computers that are infected with a bot, that is, a kind of malware, and are connected over a network. An IRC botnet was introduced in the early 1990, and a botnet using the HTTP protocol has appeared recently.

HTTP botnets may be classified into the following types: internal data divulgence-type botnets, such as Zeus, that are intended to capture internal data such as financial transaction information, DDoS attack-type botnets that are intended to make DDoS attacks, and spam-type botnets that propagate via e-mail, download additional malware, and cause widespread damage. Variants and new types of bots continue to appear.

In the case of an Internet Relay Chat (IRC) botnet, a network operator can block a specific port that is used by a bot at a firewall. In contrast, it is impossible to block port 80 (HTTP) that is used by an HTTP botnet because port 80 is a general-purpose port. Therefore, it is actually impossible to prevent the activities of an HTTP botnet.

Furthermore, since the HTTP botnet exchanges information with an intermediate server using the same method as normal web communication, it is difficult to detect an HTTP botnet until a specific HTTP bot is analyzed, and optimized detection rules are specified and applied to Intrusion Detection System (IDS) equipment.

So far, due to the detection method dependent on an intermediate server and IP information, it is impossible to detect a new type of HTTP botnet, or an accurate decision is difficult to make because of ambiguous decision criteria even if traffic that is suspected of being produced by a new type of HTTP botnet is detected.

In order to overcome this problem, a botnet group detection system using a group behavior matrix formed by grouping traffic patterns, such as a client's Domain Name System (DNS) query, has been introduced.

However, the botnet group detection system using a group behavior matrix is disadvantageous in that it can detect a bot only in a large-scale network in which group behavior can be identified and in that a bot can be detected only when there is a plurality of bots that are infected with the same malware in a corresponding network.

Furthermore, the botnet group detection system is disadvantageous in that it is subject to high system load upon data analysis for collection management and botnet detection because the amount of traffic information to be collected is large.

Korean Patent Application Publication NO. 2011-0070182 discloses a botnet group detection system using a network-based group behavior matrix and a botnet group detection method using a network-based group behavior matrix. The technology disclosed in this Korean patent application publication is limited in that it should be assumed that a plurality of identical bots having similar traffic behavior patterns is present in a large-scale network environment and it is necessary to collect a large amount of traffic.

Accordingly, there is an urgent need for new technology that can detect HTTP botnets.

### SUMMARY OF THE INVENTION

Accordingly, the present invention has been made keeping in mind the above problems occurring in the conventional art, and an object of the present invention is to provide an apparatus and method that can detect existing and new HTTP botnets using the characteristic of an HTTP botnet, in which the density of its web transaction is low, in a network environment, such as the environment of an organization network or an Internet Service Provider (ISP) network, that can manage client IP addresses.

In accordance with an aspect of the present invention, there is provided an apparatus for detecting an HTTP botnet based on the densities of web transactions, including a collection management unit configured to extract metadata from HTTP request packets collected by a traffic collection sensor; a web transaction classification unit configured to extract web transactions by analyzing the metadata, and to generate a gray list by arranging the extracted web transactions according to the frequency of access; and a filtering unit configured to detect an HTTP botnet by filtering the gray list based on a white list and a black list.

The collection management unit may extract metadata, including collection time, a source IP address, destination IP addresses, referer information, request methods, request domains and request URL intonation, from information of the HTTP request packets collected by the traffic collection sensor.

The web transaction classification unit may generate metadata structures, each including count information, by classifying the web transactions based on the metadata, and generate the gray list by extracting a list of metadata structures, the count information of each of which is equal to or lower than N.

The filtering unit may eliminate web transactions corresponding to entries of the white list from the gray list, extract web transactions matching entries of the black list and add the matching web transactions to an existing HTTP botnet detection list, and add web transactions corresponding to remaining entries of the gray list to a new HTTP botnet detection list, thereby performing detection of an HTTP botnet.

The apparatus may further comprise a white list generation machine configured to generate a white list, including normal web transactions, by periodically and automatically accessing a predetermined webpage, collecting web access logs, and classifying the web transactions.

The apparatus may further comprise a black list management unit configured to store and manage the black list, entries of which are input by a system operator and/or received from an external security service provider and/or a black list database.

In accordance with another aspect of the present invention, there is provided a method of detecting an HTTP botnet based on densities of web transactions, including collecting, by a collection management unit, HTTP request packets directed from an internal client to an external web server, and extracting, by a collection management unit, metadata from the HTTP request packets; generating, by a web transaction classification unit, a gray list using the metadata; and performing, by a filtering unit, detection of an HTTP botnet by filtering the gray list based on a white list and a black list.

Extracting the metadata may comprise extracting metadata, including collection time, a source IP address, destination IP addresses, referer information, request methods, request domains and request URL information, from the information of the HTTP request packets.

Generating the gray list may includes classifying the metadata according to their source IP address, and classifying the web transactions based on referer information and a time gap; generating metadata structures, such including count information, based on the metadata, and generating the gray list by extracting a list of metadata structures, the count information of each of which is equal to or lower than N; and arranging the gray list according to a frequency of access.

Performing the detection of the HTTP botnet by filtering the gray list based on the white list and the black list may comprise eliminating web transactions corresponding to entries of the white list from the gray list, extracting web transactions matching entries of the black list and adding the matching web transactions to an existing HTTP botnet detection list, and adding web transactions corresponding to remaining entries of the gray list to a new HTTP botnet detection list, thereby performing detection of an HTTP botnet.

The method may further comprise generating a white list, including normal web transactions, by periodically and automatically accessing a predetermined webpage, collecting web access logs, and classifying the web transactions.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an apparatus for detecting an HTTP botnet based on the densities of web transactions in accordance with an embodiment of the present invention;

FIG. 2 is a diagram illustrating the format of a metadata structure that is generated by a transaction classification unit in accordance with an embodiment of the present invention;

FIG. 3 is a flowchart illustrating a method of detecting an HTTP botnet based on the densities of web transactions in accordance with an embodiment of the present invention; and

FIG. 4 is a flowchart illustrating a method by which a web transaction classification unit classifies transactions in accordance with an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

Embodiments of the present invention will be described in detail below with reference to the accompanying drawings.

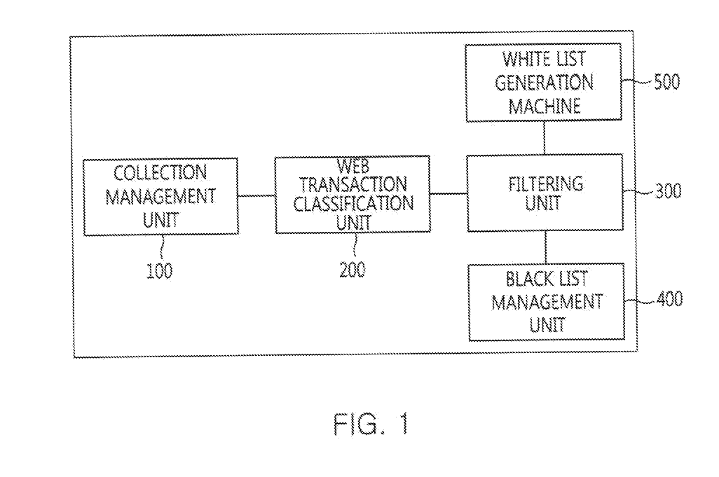

FIG. 1 is a diagram illustrating an apparatus for detecting an HTTP botnet based on the densities of web transactions in accordance with an embodiment of the present invention.

Referring to FIG. 1, the apparatus for detecting an HTTP botnet based on the densities of transactions in accordance with this embodiment of the present invention comprises a collection management unit 100, a web transaction classification unit 200, a filtering unit 300, a black list management unit 400, and a white list generation machine 500.

A web transaction is a collection of web access logs that are generated by a specific client. A web transaction is generated when a user clicks on a webpage or when an application program periodically accesses a web server over the web. A web access log is IP header and HTTP header information that is included in an HTTP request packet that is directed from a client to an external web server.

The number of web access logs included in a web transaction that is generated by an HTTP botnet has the characteristic of being significantly smaller than the number of web access logs included in a normal web transaction.

The collection management unit 100 extracts metadata from HTTP request packets that are collected by a traffic collection sensor.

In this case, the collection management unit 100 may receive HTTP request packets, directed from an internal client to an external web server, from the traffic collection sensor, and may extract metadata including collection time, a source IP address, destination IP addresses, referer information, request methods, request domains, and request URL information, from the information of the HTTP request packets that are collected by the traffic collection sensor.

The web transaction classification unit 200 extracts web transactions by analyzing the metadata, and generates a gray list by arranging the extracted web transactions according to the frequency of access.

In this case, the web transaction classification unit 200 may classify the metadata according to their source IP address, may classify the web transactions based on the referer information and the time gap (the time difference between a pair of web access logs), may generate metadata structures each including a source IP address, collection time, a count, referer information, destination IP addresses, request methods, request domains, and request URL information, and may generate a gray list by extracting metadata structures, the count information of which is equal to or smaller than N.

In this case, each of the generated metadata structures is a web transaction that includes web access logs, the number of which is equal to the count information.

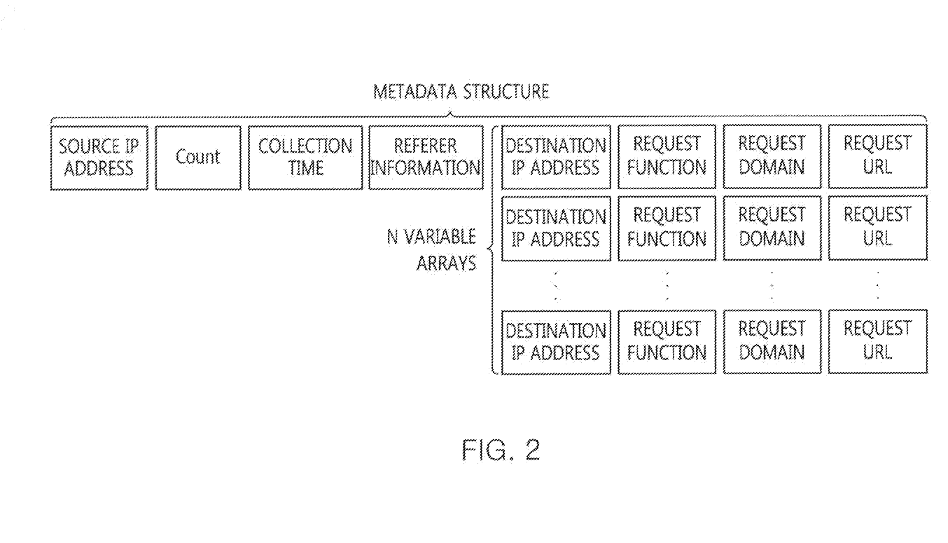

Referring to FIG. 2 in order to describe the format of a metadata structure in greater detail, sets of four items of the metadata structure, that is, the destination IP address, request method, request domain and request URL of the metadata structure, form N variable arrays inside a single structure, and the N variable arrays are arranged sequentially from a set of destination IP address, request method, request domain, and request URL of a first web access log included in a web transaction to a set of destination IP address, request method, request domain and request URL of an N-th web access log.

The metadata structure is configured to enable the density of a web transaction and the details of the web transaction to be easily determined in such a way that a count field indicative of the number of web access logs included in the web transaction (that is, the density of the web transaction) is added to metadata (including collection time, a source IP address, destination IP addresses, referer information, request methods, request domains, and request URLs), and sets of a destination IP address, a request method, a request domain, and a request URL are stored in the form of variable arrays.

In this case, the reason why the number of variable arrays is limited to a value equal to or less than N is that the probability of not being a web transaction of an HTTP bot is high if the count is larger than N and a storage space is wasted if more than N arrays are stored.

The maximum number N of variable arrays is determined depending on a value initially set by a system operator, but is variable. Since the maximum number N of variable arrays is used to identify the web access logs of an HTTP botnet having a web transaction density, it may be set to a value between 1 and 5.

Furthermore, the web transaction classification unit 200 may rearrange the gray list in order to determine the degree of suspicion based on the frequency of access.

In this case, normal web transactions included in a gray list may include the periodic update checking and performance of an OS (Operating System), the periodic update checking and performance of an application program, and the periodic web access of a script of a web page.

Meanwhile, since the above-described normal web transactions have low counts, they may be confused with web transactions generated by an HTTP botnet, and thus erroneous detection may occur.

Accordingly, in order to filter out normal web transitions, the white list generation machine 500 generates a white list.

The white list generation machine 500 generates a white list, including normal web transactions, by automatically and periodically accessing a predetermined webpage, collecting web access logs, and classifying web transactions.

The white list generation machine 500 includes one or more white list generation machines. A white list generation machine is provided for each type of OS or each version of OS that is used by a client of a control target network. Each white list generation machine includes a well-known application program, web browsing tool and web access log collection tool.

The web browsing tool generates banner traffic and script-based traffic while periodically accessing a webpage having a large number of persons who access it. The web access log collection tool collects web access logs generated by the web browsing tool and the application program, and generates metadata.

The collected metadata is input to the web transaction classification unit 200, and finally forms a white list including normal transactions, the number of which is equal to or smaller than a threshold value N.

Here, the white list includes destination IP addresses, domains, and URL information.

Furthermore, the white list generation machine 500 should be completely prevented from being infected with malware, so that it should be located in a place where security equipment, such as a firewall or an Intrusion Detection System (IDS), is installed at the front end of the place and be protected against the intrusion of an external attacker and attempts to install malware.

The black list management unit 400 stores and manages a black list, the entries of which may be input by a system operator and/or received from an external security service provider and/or a black list database.

The black list includes destination IP addresses, domains, and URL information, like the white list. The entries of the black list may be input by a system operator and/or received from an external security service provider and/or a black list database in the black list management unit 400.

The filtering unit 300 filters the gray list based on the white list and the black list.

In this case, the filtering unit 300 eliminates web transactions corresponding to entries of the white list from the gray list, extracts web transactions that matches entries of the black list and adds the extracted web transactions to an existing HTTP botnet detection list, and adds web transactions corresponding to the remaining entries of the gray list to a new HTTP botnet detection list, thereby performing the detection of an HTTP botnet.

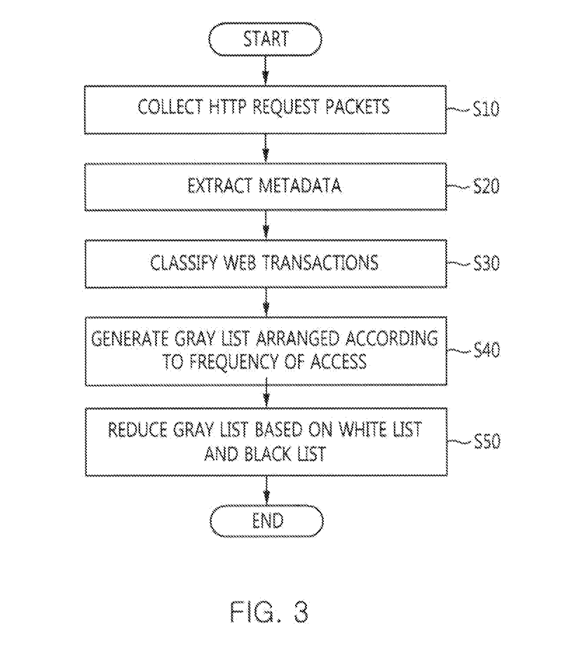

FIG. 3 is a flowchart illustrating a method of detecting an HTTP botnet based on the densities of web transactions in accordance with an embodiment of the present invention.

Referring to FIG. 3, in the method of detecting an HTTP botnet based on the densities of web transactions in accordance with this embodiment of the present invention, first, the collection management unit 100 collects HTTP request packets directed from an internal client to an external web server at step S10, and extracts metadata from the HTTP request packets at step S20.

In this case, the collection management unit 100 may receive the HTTP request packets, directed from the internal client to the external web-server, from a collection sensor, and may extract metadata, each including collection time, a source IP address, destination IP addresses, referer information, request methods, request domains and request URL information, from the information of the collected HTTP request packets collected by the traffic collection sensor.

Thereafter, the web transaction classification unit 200 classifies web transactions using the metadata at step S30, and generates a gray list arranged based on the access frequency at step S40.

In this case, the metadata may be classified according to their source IP address, the web transactions may be classified based on the referer information and the time gap, metadata structures each Including count information may be generated, a gray list may be generated by extracting metadata structures, the count information of which is equal to or smaller than N, and the gray list may be arranged according to the frequency of access.

Furthermore, the web transaction classification unit 200 may rearrange the gray list in order to determine the degree of suspicion based on the frequency of access.

In this case, normal web transactions included in a gray list may include the periodic update checking and performance of an OS, the periodic update checking and performance of an application program, and the periodic web access of a script of a web page.

The white list may be generated through the step of including normal web transactions by automatically and periodically accessing a predetermined webpage, collecting web access logs, and classifying web transactions.

The black list may be generated in such a way that the entries of the black list are input by a system operator and/or received from an external security service provider and/or a black list database.

Thereafter, the filtering unit 300 reduces the range of the gray list by filtering the gray list based on the white list and the black list at step S50.

In this case, the detection of an HTTP botnet may be performed by eliminating web transactions corresponding to entries of the white list from the gray list, extracting web transactions matching entries of the black list and adding the extracted web transactions to an existing HTTP botnet detection list, and adding web transactions corresponding to the remaining entries of the gray list to a new HTTP botnet detection list.

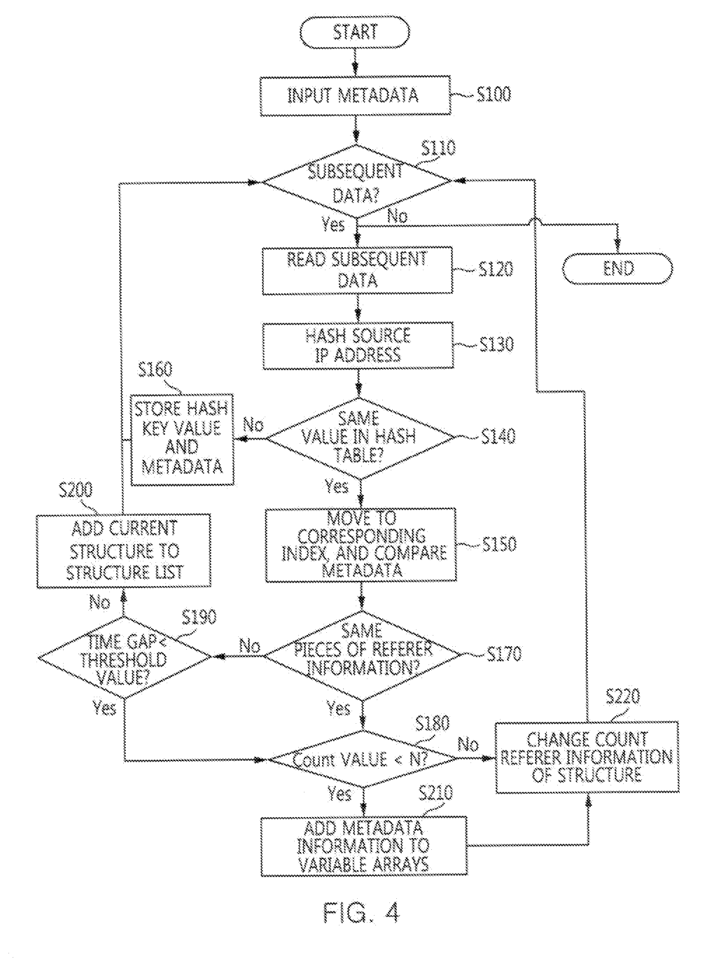

FIG. 4 is a flowchart illustrating a method by which the web transaction classification unit 200 classifies transactions in accordance with an embodiment of the present invention.

Referring to FIG. 4, in the method by which the web transaction classification unit 200 classifies transactions in accordance with an embodiment of the present invention, first, metadata extracted by the collection management unit 100 is received at step S100, and it is determined that subsequent data is present is determined and then data is read at steps S110 and S120.

Thereafter, hashing is performed using the source IP address of the metadata as a key value at step S130, whether a value identical to the key value is present in a hash table is determined at step S140, the current key value and the metadata is stored if there is no identical value at step S160, and the items of previously recorded metadata are compared with those of the currently read metadata if there is an identical value at step S150.

Thereafter, the referer information of the previously stored metadata is compared with the referer information of the currently read metadata at step S170, and the time gaps thereof are compared with each other if the referer information of the previously recorded metadata is not the same as the referer information of she currently read metadata referer information at step S190

In this case, the time gap is a criterion that is used to classify a transaction.

If the time gap exceeds a threshold value, it is determined that the currently read metadata and the previously stored metadata are different transactions, and the currently read metadata structure is added to a structure list, thereby classifying the transaction at step S2O0.

If the time gap does not exceed the threshold value, it is determined that the currently read metadata and the previously stored metadata are the same transactions, and the count value is checked at step S180.

If it is determined that the count value is smaller than N, metadata information is added to the variable arrays of the structure at step S210. In contrast, if it is determined that the count value is equal to or larger than N, the count referer information of the structure is increased at step S220.

The apparatus and method for detecting an HTTP botnet based on the densities of web transactions in accordance with the present invention is not limited to the configurations and methods the above-described embodiments, but all or parts of the embodiments may be selectively combined so that the embodiments can be modified in various ways.

In accordance with the present invention, an HTTP botnet can be detected regardless of the sizes of a control target network and a botnet because the HTTP botnet is detected based on the densities of web transactions, and a new HTTP botnet can be precisely detected because the filtering of a white list and the rearrangement of detection results based on the frequency of access are performed.

Furthermore, the present invention is subject to low system load upon data collection management and collection data analysis compared to a conventional botnet detection system that requires the collection of all traffic or the traffic of lower level protocols, such as TCP and UDP, because only HTTP request packets are collected to detect an HTTP botnet.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for detecting a Hyper Text Transfer Protocol (HTTP) botnet based on densities of web transactions, comprising:
a collection management unit configured to extract metadata from HTTP request packets collected by a traffic collection sensor;
a web transaction classification unit configured to extract web transactions by analyzing the metadata, and to generate a gray list by arranging the extracted web transactions according to a frequency of access; and
a filtering unit configured to detect an HTTP botnet by filtering the gray list based on a white list and a black list.

2. The apparatus of claim 1, wherein the collection management unit extracts metadata, including collection time, a source IP address, destination IP addresses, referer information, request methods, request domains and request URL information, from information of the HTTP request packets collected by the traffic collection sensor.

3. The apparatus of claim 1, wherein the web transaction classification unit generates metadata structures, each including count information, by classifying the web transactions based on the metadata, and generates the gray list by extracting a list of metadata structures, the count information of each of which is equal to or lower than N.

4. The apparatus of claim 1, wherein the filtering unit eliminates web transactions corresponding to entries of the white list from the gray list, extracts web transactions matching entries of the black list, and adds the matching web transactions to an existing HTTP botnet detection list, and adds web transactions corresponding to remaining entries of the gray list to a new HTTP botnet detection list, thereby performing detection of an HTTP botnet.

5. The apparatus of claim 1, further comprising a white list generation machine configured to generate a white list, including normal web transactions, by periodically and automatically accessing a predetermined webpage, collecting web access logs, and classifying the web transactions.

6. The apparatus of claim 1, further comprising a black list management unit configured to store and manage the black list, entries of which are input by a system operator and/or received from, as external security service provider and/or a black list database.

7. A method of detecting an HTTP botnet based on densities of web transactions, comprising:
collecting, by a collection management unit, HTTP request packets directed from an internal client to an external web server, and extracting, by the collection management unit, metadata from the HTTP request packets;
generating, by a web transaction classification unit, a gray list using the metadata; and
performing, by a filtering unit, detection of an HTTP botnet by filtering the gray list based on a white list and a black list.

8. The method of claim 7, wherein extracting the metadata comprises extracting metadata, including collection time, a source IP address, destination IP addresses, referer information, request methods, request domains and request URL information, from information of the HTTP request packets.

9. The method of claim 7, wherein generating the gray list comprises:
classifying the metadata according to their source IP address, and classifying the web transactions based on referer information and a time gap;
generating metadata structures, each including count information, based on the Metadata, and generating the gray list by extracting a list of metadata structures, the count information of each of which is equal to or lower than N; and
arranging the gray list according to a frequency of access.

10. The method of claim 7, wherein performing the detection of the HTTP botnet by filtering the gray list based on the white list and the black list comprises:
eliminating web transactions corresponding to entries of the white list from the gray list, extracting web transactions matching entries of the black list and adding the matching web transactions to an existing HTTP botnet detection list, and adding web transactions corresponding to remaining entries of the gray list to a new HTTP botnet detection list, thereby performing detection of an HTTP botnet.

11. The method of claim 7, further comprising, generating a white list, including normal web transactions, by periodically and automatically accessing a predetermined webpage, collecting web access logs, and classifying the web transactions.
